(19) United States
(12) Patent Application Publication
(10) Pub. No.: US 2002/0038338 A1
(43) Pub. Date: Mar. 28, 2002

(54) Method and system for real-time data display scheduling

(76) Inventors: Hsiang Tsun Yen, Taipei (TW); Chien Sen Weng, Taipei (TW); Luke Taylor, Taipei (TW)

Correspondence Address: Michael D. Bednarek, SHAWPITTMAN, 1650 Tysons Boulevard, McLean, VA, 22102-4859, US

(21) Appl. No.: 09/865,471

(22) Filed: May 29, 2001

(30) Foreign Application Priority Data
Sep. 14, 2000 (TW) 089119020

(51) Int. Cl. G06F 15/16; G06F 7/00; G06F 17/00

(52) U.S. Cl. 709/203; 707/104.1

(57) ABSTRACT

A method and system for real-time data display scheduling for providing a user an alternative data display on the Internet and a customized real-time data display to meet user's demand. The system includes: a server and at least one client. The server is used for receiving requests for channel-data and providing corresponding channel-data in response to the requests. Each channel-data further includes a designated timer and a designated queue number. The client further includes a user interface unit, a plurality of queues, and a plurality of channel units. The channel unit sends a request for channel-data. Then the channel units receives the corresponding channel-data, defines the time to enter into a plurality of queues according to the timer of the channel-data, and defines the order of the channel-data in the corresponding queue according to the queue number of the channel-data.

### REFERENCE TO RELATED APPLICATIONS

This application claims the benefit of priority under 35 U.S.C. § 119(a) of Taiwan Patent Application No. 089119020, filed on Sep. 14, 2000.

### BACKGROUND OF THE INVENTION

1. Field of the Invention

The present invention relates generally to Internet browsing. More specifically, the present invention relates to a method and system for real-time data display scheduling so as to provide users alternative data display while accessing to the Internet and to provide customized real-time data display by users' demand.

2. Description of the Related Art

Among prior art, hyperlinks are the important means for Internet browsing. In other words, users link to corresponding web pages via clicking on a hyperlink with a mouse. The web pages are organized in a hierarchical order based on the content of the web pages. After going through the headings with hyperlinks and text summaries, users decide whether to read full-length articles by clicking on the corresponding headings, i.e. hyperlinks. The presentation of the current real-time news on the Internet adapts the same method, users have to go to the web site where the real-time news headings lists are and click on the heading to receive latest news updates.

In other words, users have to repeat steps such as launching a browser, linking to a news websites, downloading web pages with news, going through headings, checking if there are new headings, then clicking on the news headings in order to receive full length stories. In addition, when browsing web pages, users are required to scroll each document page-by-page or line-by-line with scrolls of the browser to continue reading. In other examples, some web pages are coded with java script to enable a dynamic text display on the web pages. Provided dynamic text displays are embedded with hyperlinks, users are also permitted to click on the dynamic text display to read full-length stories. Each dynamic text display links to a web page.

### SUMMARY OF THE INVENTION

In view of the limitations of the prior art, the present invention discloses a method and system for real-time data display scheduling, which rotates real-time data continuously. The present invention provides an alternative data display on the Internet to permit a user access to real-time data at a client by browsing data on a user interface provided by a server. The real-time data is collected and assorted into channels by the server. Assorted channels are displayed real-time at the client.

The system for real-time data scheduling comprises a server, which collects real-time data with a channel management unit and assorts the real-time data into a plurality of channel-data. A schedule management unit and priority management unit gives each channel-data a timer and a priority number depending on time reference and the status of the channel-data separately. The channel-data is temporarily saved in the server database.

A client comprises a user interface, a channel-data switching unit and a plurality of channel units. A channel unit makes a channel request. When the server receives the channel request, the server retrieves corresponding channel-data in the database and sends the channel-data to the channel unit in response to the channel request. The channel unit receives the channel-data from the server. It determines the priority based on the priority number designated to the channel-data, and it also determines whether a corresponding queue is generated in the client. If yes, a corresponding queue exists, and then the channel-data determines the time to enter the corresponding queue based on the timer designated to the channel-data. A channel-data switching unit retrieves channel-data in accordance with the priority of the queue and the FIFO (first in first out) rule. Retrieved channel-data is displayed on the user interface. After the channel-data is displayed, the client is allowed to make a following request for channel-data to the server.

The user interface displays the channel-data retrieved by the channel-data switching unit. The display format of the channel-data is open to system set up. For example, display the lines of text in the content in an upward direction. The user interface also provides additional functions, for example, the current channel-data displayed on the user interface can be saved in a text file, printed with a printer or forwarded to a friend etc.

When the channel-data switching unit retrieves channel-data in queues, it follows the priority of the queues. In other words, only when channel-data in a queue with higher priority is empty, the channel-data switching unit moves to retrieve the channel-data from another queue with lower priority. On the other hand, when new channel-data enter the queue with higher priority, the channel-data switching unit finishes current displaying of the retrieved channel-data and then switch back to the queue with higher priority to retrieve channel-data. Such arrangement is convenient when it is an urgent need to display channel-data immediately.

When queues are empty, designated channel unit makes a request for advertisement channel to avoid an empty user interface. In other words, advertisements fill in before the user interface turns empty and blank.

A client further comprises a plurality of queues, which includes an advertisement queue. The advertisement queue is used for saving advertisements. Each queue is has an assigned number representing their priority. When a client makes a channel request, the server sends a corresponding data to a corresponding channel unit at a client. The channel-data sent is designated a timer and a scheduled queue number before data being sent. When the client receives channel-data from the server, the timer of the channel-data defines the time to enter into the queue, and the queue number of the channel-data defines which queue to enter into for the channel-data.

The channel-data switching unit executes following steps following the priority in the corresponding queues and retrieving channel-data from the corresponding queues. The user interface unit is responsible for displaying the retrieved channel-data, it makes request for following request for channel-data till the current data is displayed. Upon receiving following request for d\channel-data, the server then continues to send corresponding channel-data to corresponding channel unit in the client. Each client is permitted to include specific channel units based on demands. It is allowed to make request for specific channel-data to the server, and receive specific channel-data. Such arrangement allows the client to receive real-time data in demands.

Utilizing queues as a buffer for continuous display of channel-data, it gives sufficient download time for a server. In addition, the timer, priority number and queue number of the channel-data, combining with the reserved priority queue together it further permits more flexibility for a efficient channel-data scheduling and guarantees channel-data to be displayed immediately in urgent condition.

The invention discloses a system and method for real-time data scheduling. It does not provide feature to meet individual demands for displaying real-time data, also it eliminates redundant operations in the prior art such as launching a browser, reloading set ups, downloading web pages, going through all headings, and then clicking on a heading. In addition, it also saves users' effort to scroll a document page-by-page or line-by-line with scrolls of a browser for continuing reading.

### BRIEF DESCRIPTION OF DRAWINGS

The following detailed description, given by way of an example and not intended to limit the invention to the embodiments described herein, will best be understood in conjunction with the accompanying drawings, in which:

FIG. 1 illustrates a functional block diagram of a system for real-time data scheduling according to the preferred embodiment of the invention;

FIG. 2 illustrates a perspective view of a system for real-time data scheduling according to the preferred embodiment I of the invention;

FIG. 3 illustrates a flowchart 1 of a system for real-time data scheduling according to the preferred embodiment I of the invention;

FIG. 4 illustrates a flowchart 2 of a system for real-time data scheduling according to the preferred embodiment I of the invention;

FIG. 5 illustrates a functional diagram of a system for real-time data scheduling according to the preferred embodiment II of the invention;

FIG. 6 illustrates perspective view of a system for real-time data scheduling according to the preferred embodiment II of the invention; and

FIG. 7 illustrates a flowchart 1 of a system for real-time data scheduling according to the preferred embodiment II of the invention.

### DETAILED DESCRIPTION OF THE INVENTION

Preferred Embodiment I

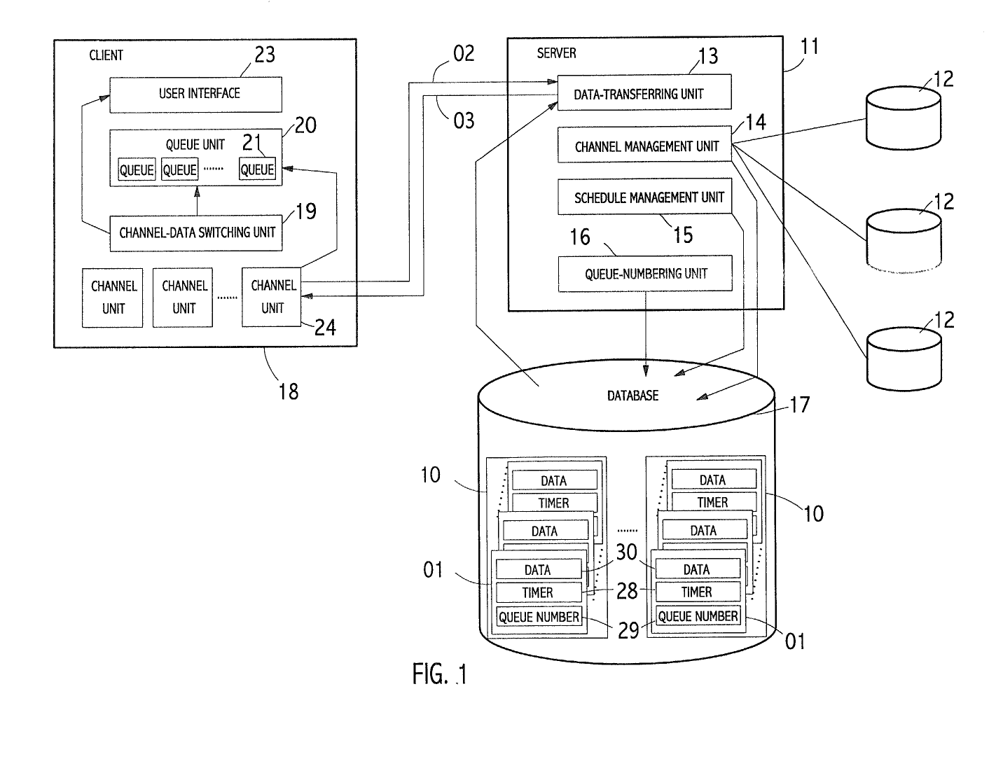

The present invention discloses a system and method for real-time data scheduling, which provides users an alternative means in browsing the Internet. FIG. 1 illustrates a functional block diagram of a system for real-time data scheduling according to the preferred embodiment I of the invention. The system includes a server 11 and a client 18. The server 11 simultaneously retrieves and sends required channel-data to a plurality of clients 18. The present embodiment shown is a simplified example, which includes a server 11 and a client 18. The server 11 comprises a data-transferring unit 13, a channel management unit 14, a schedule management unit 15 and a queue-numbering unit 16.

The channel management unit 14 is used for collecting external data 12, assorting the external data 12 into a plurality of channel-data 01, and saving in a channel location 10 in a database 17. Each channel location 10 has a plurality of channel-data 01. A schedule management unit 15 assigns each channel-data 01 a specific timer 28. A queue-numbering unit 16 assigns each channel-data 01 a specific a queue number 29 subject to user's requirements.

The client 18 comprises a user interface 23, a queue unit 20, a channel-data switching unit 19 and a plurality of channel units 24. When a channel unit 24 in the client 18 makes a channel request 02 to the server 11, the data-transferring unit 13 in the server 11 receives the channel request 02 from the channel unit 24 in the client 18. The data-transferring unit 13 retrieves corresponding channel-data 01 in the database 17 in response to the channel requests 02, and sends the channel-data 01 via channel-data-transferring 03 to the channel unit 24.

The channel unit 24 receives the channel-data 01 from the server 11. The timer 28 and the queue number 29 of each channel-data 01 are used for determining a time for the data 30 of the channel-data 01 to enter into corresponding queues 21 in the queue unit 20. As a channel-data 01 enters into the queues 21. It follows a FIFO (first in first out) rule. The data 30 of the channel-data 01 is either inserted into queues 21 or linked to the queues 21.

The channel-data switching unit 19 is used for maintaining the retrieving operation of data 30 in the queues 21. It displays the data 30 on the user interface unit 23. When the channel-data switching unit 19 retrieves data 30 in the queues 21, it follows the order according to the pre-determined queue number of the channel-data 01 in the queues 21 (not shown in the diagrams). The priority determines by the order of the queue number. Only when data 30 from the queues 21 with higher priority is displayed, the channel-data switching unit 19 moves onto retrieves the data 30 in a queues 21 with lower priority.

When there is no data 30 all queues 21 in the queue unit 20, in other words, no data 30 is available to be displayed in the user interface unit 23, then The channel unit 24 makes advertisement channel requests (not shown in the diagrams) to the server 11, serving as channel requests 02. When the data-transferring unit 13 receives the requests, it retrieves the pre-scheduled advertisement data in the database 17 in the server 11, and assigns a timer and a queue number to each advertisement data as the same steps applied to the channel-data 01. Same as the fact that a queue number 29 of a channel-data 01 is determined based on the user's requirements, the timer 28 and the queue number 29 are often assigned with lower priority such that the channel-data 01 with a higher priority can plug in when desired.

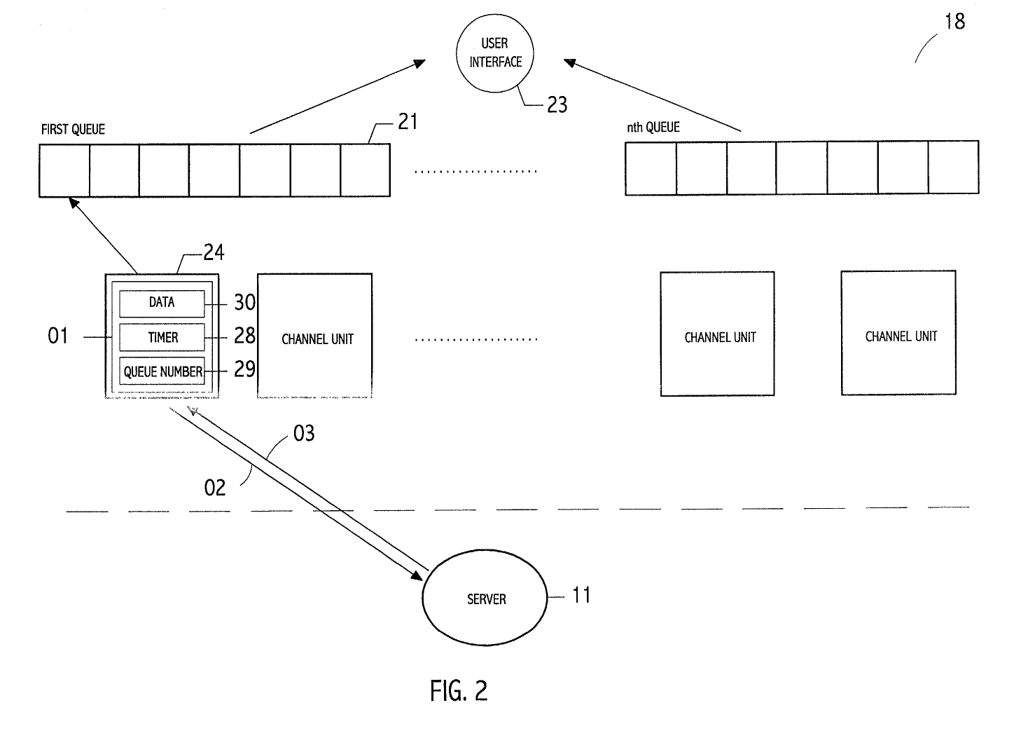

FIG. 2 illustrates a perspective view of a system for real-time data scheduling according to the preferred embodiment I of the invention. The quantity of queues 21 in a queue unit 20 is determined by user's requirements. As shown in the FIG. 2, there are n queues counting from the first queue 21 to the nth queue. Provided in the priority ranking the first queue 21 is in the highest priority and the nth queue is in the lowest priority. Accordingly, the first queue 21 is in higher priority than the second queue (not shown in the diagrams), the second queue is in higher priority than the third queue (not shown in the diagrams) respectively.

When a channel unit 24 in the client 18 makes a channel request 02 to the server 11, the server 11 receives the channel request 02; it retrieves channel-data 01 (referring to FIG. 1) in the channel location 10 of the database 17. The channel-data is assigned a timer 28 and queue number 29 by the queue-numbering unit 16 and the schedule management unit 15 in the server 11 in advance.

After data retrieving, the data-transferring unit 13 in the server 11 simultaneously sends the required channel-data via channel-data-transferring 03 to the channel unit 24 that made the channel request 02. Upon receiving the channel-data 01 sent by the channel-data-transferring 03 at the channel unit 24 in the client 18, the timer 28 of the channel unit 24 starts to determine the time for the channel-data 01 to enter into the queues 21. In addition, queue number 29 of the channel-data 01 involves with the time to enter into the queues 21.

For example, the timer 28 of the channel-data 01 is set as one minute after the timer 28 is launched and the queue number 29 is set in the first queue. As a result, upon channel unit 24 receiving corresponding channel-data 01 from the server 11, the timer 28 of the channel-data 01 is launched at the same time. It follows that in one minute, the data 30 of the channel-data 01 then is either directly inserted in the first queue 21 or linked to the first queue 21. When the channel-data switching unit 19 retrieves data 30 in the first queue 21 and sends it to the user interface unit 23, the corresponding channel unit 24 continues to make channel request 02 to the server 11 so as to maintain a continuous and simultaneous channel-data 01 display.

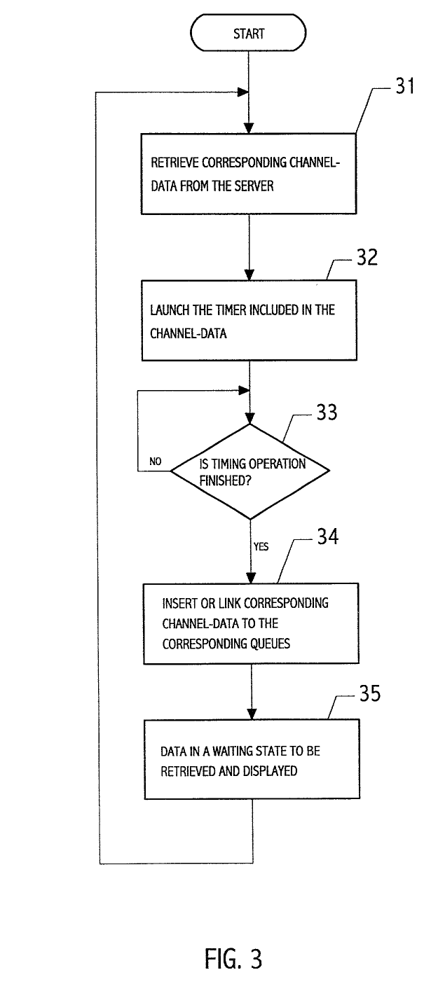

FIG. 3 illustrates a flowchart for operation steps in the client 18. The steps detail the flow of data retrieving of the channel-data 01. At step 31, each channel unit 24 in the client 18 makes a channel request 02 to the server 11. The server 11 retrieves corresponding channel-data 01. When the channel units 24 retrieve the channel-data 01 from the server 11, at step 32, the timer 28 included in the channel-data 01 is launched.

At step 33, after the timer 28 is launched, starts the operation and determines the time to enter into the queue 21. If the timing is not finished yet, the control moves to step 33. If yes, the queue number 29 of the channel-data 01 inserts or links the data 30 in the channel-data 01 to the corresponding queues 21. At step 35, data 30 is in a waiting state to be retrieved and displayed.

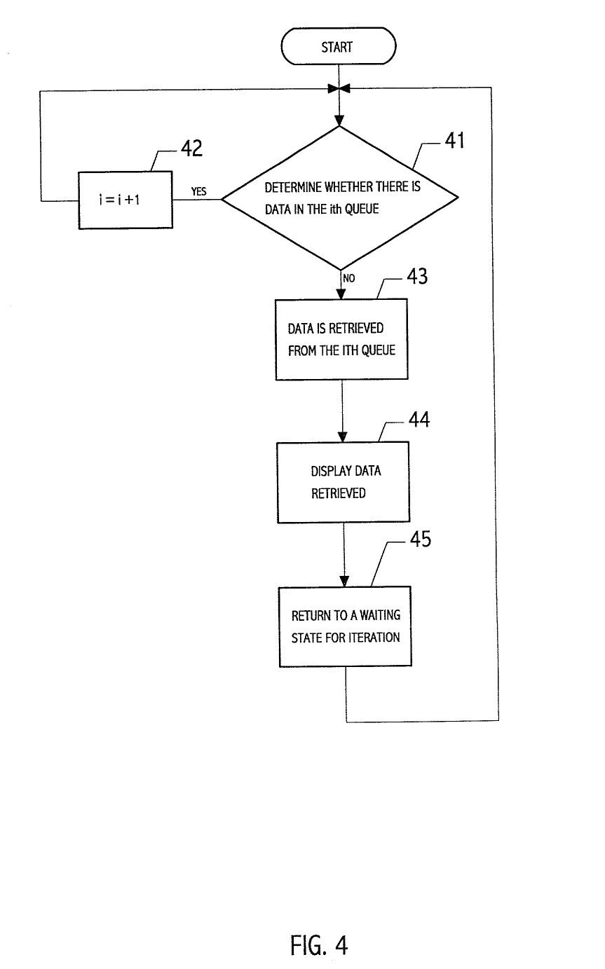

FIG. 4 illustrates a flowchart for the operation of the channel-data switching unit 19. At step 41, the channel-data switching unit 20 determines whether there is data 30 in the ith queue waiting to be retrieved and displayed, wherein i represents a queue number. If yes, the control moves to step 42. The channel-data switching unit 19 follows a rule as i=i+1 and repeat the step 41. If not, the control moves to step 43. At step 43, the data 30 is retrieved from the ith queue 21. The retrieving order is based on the time each data 30 enters the queues 21.

The data, which enters in the ith queue earlier, has a higher priority to be retrieved first. Thereafter the data 30 is displayed, the flow moves to step 45, wherein the channel-data 01 corresponding to the data 30 returns to a waiting state by executing step 35 in the FIG. 3. At step 35, the flow returns to step 31, the channel-data 01 is returns to a waiting state to iterate the steps from step 41. Such the channel unit 24 is allowed to continue to make channel request 02 to the server 11 for retrieving following corresponding channel-data 01.

According to the embodiment demonstrated in the FIG. 4, the client 18 defines the upper limit of i described in both step 41 and 42 as the maximum. When the retrieving proceeds to the (i+1) th queue, provided there is immediate data 30 enters the ith queue or any queue with a queue number smaller than (i+1), according to the rule, where queues 21 with higher priority is allowed to plug in a queue with lower priority. As a result, the immediate data then enters the queue with higher priority.

For example, when none data 30 is available in the first queue 21, the flow moves to the second queue 21 for data retrieving and displaying. The second queue 21 includes first data 30 and second data 30. When the second queue retrieves and displays the first data 30 according to the pre-determined priority, the second data 30 is then retrieved and displayed after the first data 30 being retrieved and displayed. Provided there is third data 30 plug in the first queue 21 immediately, then the third data 30 is retrieved and displayed after the display of the first data 30. This is because the first queue 21 has a higher priority than the second queue 21. Accordingly, the retrieving operation is rescheduled from retrieving the second data 30 in the second queue 21 to retrieving the third data 30 in the first queue 21.

Following the completion of the display of the third data 30 in the first queue 21, the second data in the second queue 21 is then retrieved and displayed. Such feature does not only allow an immediate plug-in for the data display but also enable a complete real-time data for users.

The queues 21 included in the queue unit 20 are pre-determined in the system. Alternatively, the channel-data 01 can be assigned a pre-determined priority number so that the quantity of queues in the client 18 can dynamically generated according to the priority number. The following embodiment is described to demonstrate said feature.

Preferred Embodiment II

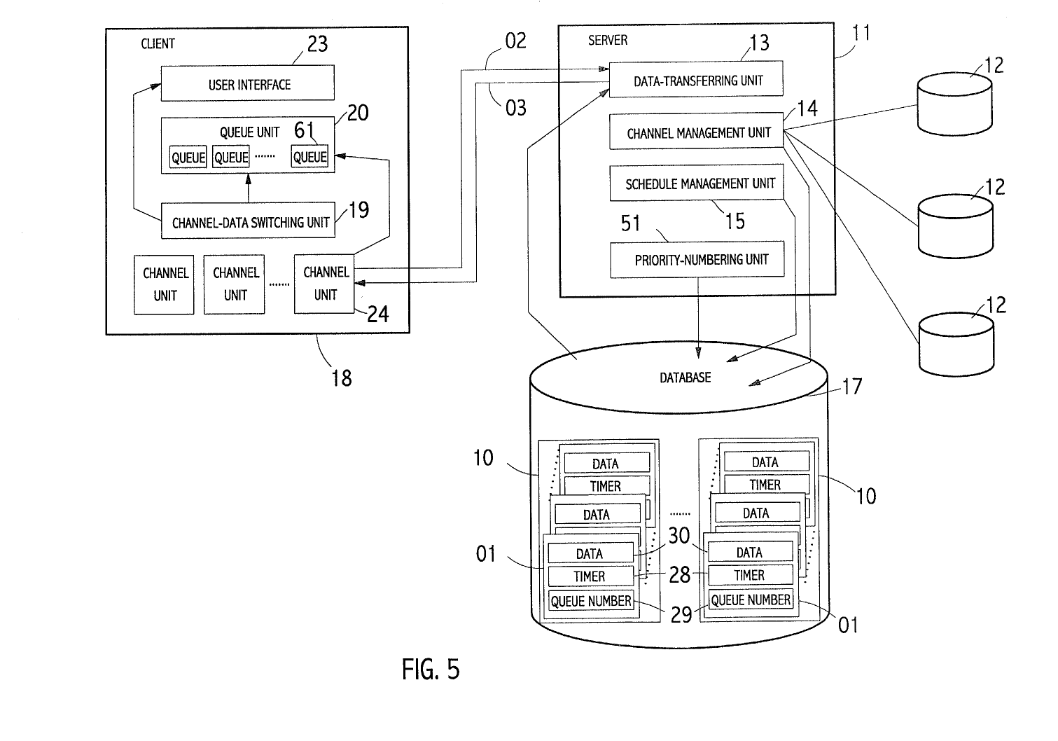

Referring to FIG. 5, the main difference between embodiments demonstrated in FIG. 1 and 5 lies in that the queue-numbering unit 16 in the server 11 in the FIG. 1 is now substituted with a priority-numbering unit 51 in FIG. 5. According to the preferred embodiment II shown in the FIG. 5, the server includes a server 11 and a client 18. The server 11 includes a data-transferring unit 13, a channel management unit 14, a schedule management unit 15 and a priority-numbering unit 51.

The channel management unit 14 is used for collecting external data 12, assorting the external data 12 into a plurality of channel-data 01, and saving in a channel location 10 in a database 17. Each channel location 10 has a plurality of channel-data 01. A schedule management unit 15 assigns each channel-data 01 a specific timer 28. A priority-numbering unit 51 assigns each channel-data 01 a specific a queue number 29 according to user's requirements.

The client 18 comprises a user interface 23, a queue unit 20, a channel-data switching unit 19 and a plurality of channel units 24. When a channel unit 24 in the client 18 makes channel request 02 to the server 11, data-transferring unit 13 in the server 11 receives the channel request 02 from the channel unit 24 in the client 18. The data-transferring unit 13 retrieves corresponding channel-data 01 in the database 17 in response to the channel requests 02, and sends the channel-data 01 via channel-data-transferring 03 to the channel unit 24.

The channel units 24 receive the channel-data 01 from the server 11. The timer 28 and queue number 29 of each channel-data 01 are used for determining a time for the data 30 of the channel-data 01 to enter into corresponding queues 61 in the queue unit 20. Whereas, the priority number 62 of the channel-data 01 is used for determining the whether corresponding queues 61 is available. If not, the client 18 generates corresponding queues 61. If yes, the data 30 of the channel-data 01 is either inserted into the queues 21 or linked to the queues 21 as a corresponding step according to the preferred embodiment 1, which is shown in the FIG. 1.

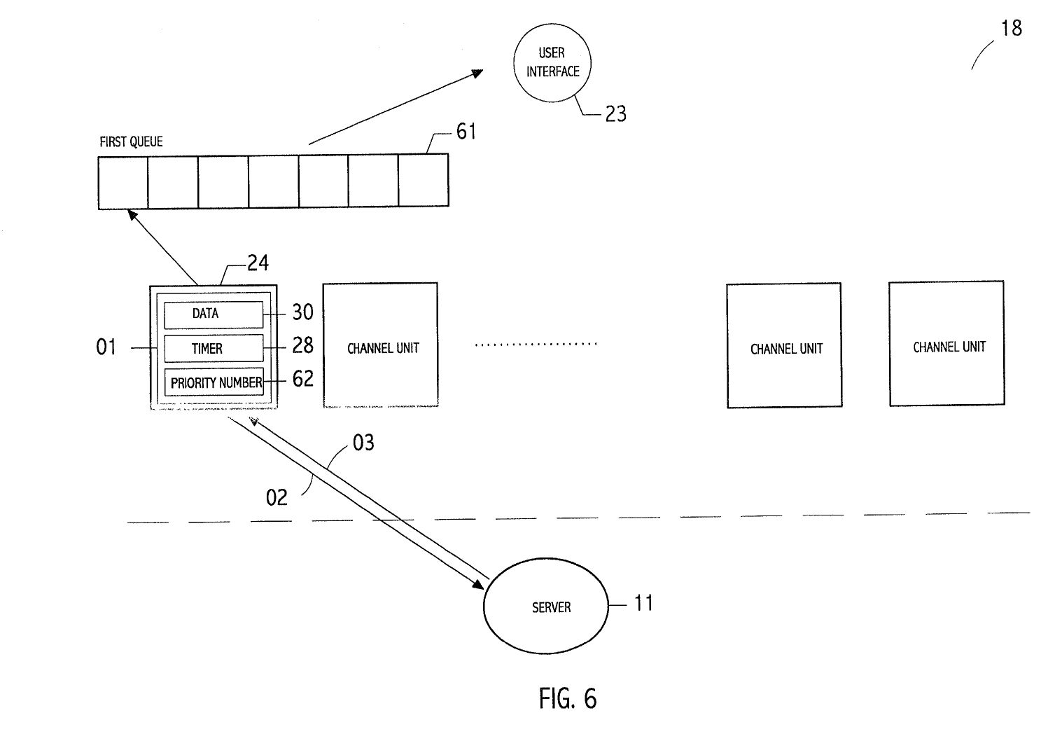

FIG. 6 illustrates a perspective view of a system for real-time data scheduling according to the preferred embodiment II of the invention. A channel unit 24 in the client 18 makes a channel request 02 to the server 11. In return, the server 11 immediately retrieves the corresponding channel-data 01 in the database 17. Whereas a timer 28 and a priority number 62 has been assigned to the channel-data 01. Thereafter the data retrieving, the server 11 sends the data via channel-data-transferring 03 to the channel unit 24.

Upon the channel unit 24 receiving the channel-data 01, the timer 28 of the channel unit 24 starts to operate. The priority number 62 of the channel unit 24 is used for determining whether there is a corresponding queue 61 in the queue unit 20. If there is a queue 61 existing in queue unit 20, channel unit 24 either inserts or links the data 30 of the channel-data 01 to the corresponding queue 61 according to the priority number 29 of the channel-data 01 after the timer 28 finishes the timing operation.

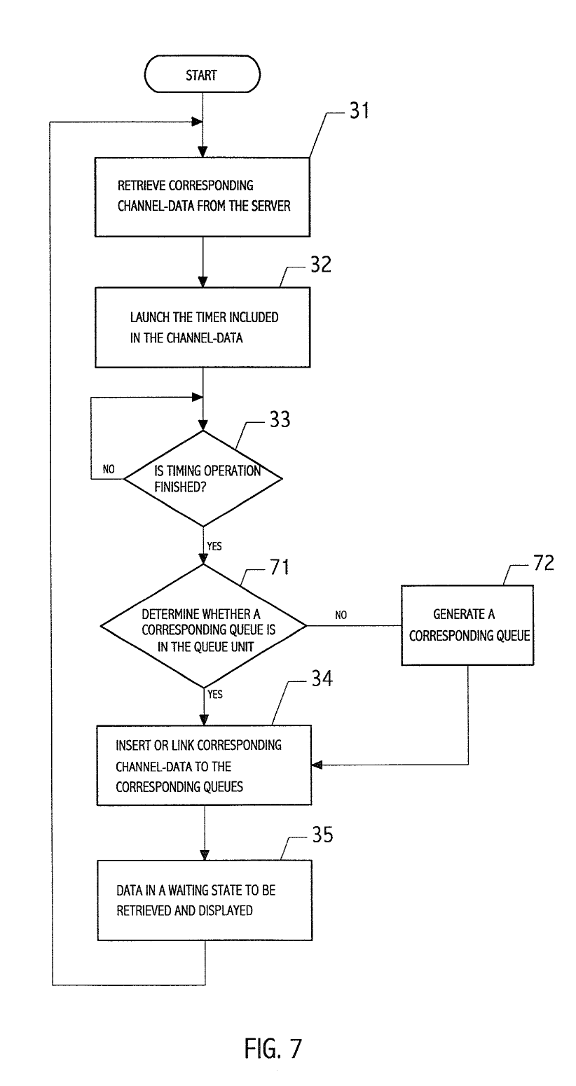

FIG. 7 is a flowchart describing steps follows the operations shown in FIG. 5 and 6. Steps 31, 32, 33, 34 and 35 in FIG. 7 are the equivalent to the steps shown in the FIG. 3. Identical elements are designated same identifying numbers. However, between step 33 and step 34, steps 71 and 72 are added for distinguishing the second preferred embodiment II to give a clearer picture of the data-retrieving step of the channel units 24. At step 31, each channel unit 24 of the client 18 makes a channel request 02 to the server 11 and retrieves corresponding the channel-data 01 from the server 11.

At step 32, upon receiving the channel-data at the channel unit 24 from the server 11, the timer 28 included in the channel-data 01 is launched. At step 33, the timer 28 determines whether the timing operation is finished. If not, the flow remains at step 33 and moves to step 71 when the timing operation is finished. At step 71, the client determines whether a corresponding queue 61 is in the queue unit 20. If yes, data 30 of the channel-data 01 is either inserted into queues 21 or linked to the queues 61. If not, the control moves to step 72, the client generates a corresponding queue 61 and the data 30 of the channel-data 01 is either inserted into queues 21 or linked to the queues 61. At step 35, the data 30 of the channel-data 01 is in a waiting state to be retrieved and displayed. Referring to the FIG. 4, the display and retrieving means are the same as the corresponding steps shown in the FIG. 4.

In both preferred embodiments, retrieved real-time data in each channel-data 01 is independent. Accordingly, the data is displayed on the user interface 23 in the client 18 continuously as the display format of the production team that is be shown at the end of the film. The data is represented in textual lines and updates simultaneously. Textual lines shift as a stream during real-time update. The client 18 is allowed to suspend the display to permit user to have a closer look of the data, print or save the data for reference.

While the invention has been described with reference to various illustrative embodiments, the description herein should not be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A method for real-time data scheduling for displaying real-time data using a server, the server collecting a plurality of data, assorting the data into a plurality of channel-data, giving a queue number and a timer on each channel-data, the client having a user interface, a plurality of queues, a plurality of channel receiving unit and a channel-data switching unit, the method for real-time data scheduling comprising:
a. making a channel request to the server from the channel unit;
b. receiving the channel request in the server and transferring the corresponding channel-data to the channel receiving unit;
c. receiving the channel-data in the channel unit, defining the time to enter into a plurality of queues according to the timer of the channel-data, and defining the order of the channel-data in the corresponding queue according to the queue number of the channel-data; and
d. retrieving the channel-data in the channel-data switching unit in the queues, displaying the data by the user interface unit and repeating step (a).

2. The method for real-time data scheduling of claim 1, wherein the queue number defines the priority of the data display.

3. The method for real-time data scheduling of claim 2, wherein the channel-data with higher priority of the data display is displayed prior than the channel-data with lower priority of the data display.

4. The method for real-time data scheduling of claim 2, wherein when the channel-data with higher priority of the data display cut in the queue, the channel-data with higher priority of the data display is displayed prior than the channel-data with lower priority of the data display.

5. The method for real-time data scheduling of claim 1, wherein the channel-data display in the queue follows the FIFO (first in first out) rule.

6. The method for real-time data scheduling of claim 1, wherein when the channel-data in a plurality of queues is empty, pre-determined data with timer defining the display time of a later period is displayed simultaneously.

7. The method for real-time data scheduling of claim 6, wherein the pre-determined data is an advertisement.

8. The method for real-time data scheduling of claim 1, wherein the server provides the user interface.

9. The method for real-time data scheduling of claim 1, wherein the channel-data is dependent upon client request of including a selected plurality of channel units.

10. A method for real-time data scheduling for displaying real-time data using a server, the server collecting a plurality of data, assorting the data into a plurality of channel-data, giving a priority number and a timer on each channel-data, the client having a user interface, a plurality of queues, a plurality of channel receiving unit and a channel-data switching unit, the method for real-time data scheduling comprising:
a. making a corresponding channel request to the server from the channel unit;
b. receiving the channel request in the server and transferring the corresponding channel-data to the channel receiving unit;
c. receiving the channel-data in the channel unit, determining whether the client generates a corresponding queue according to the priority number of the channel-data, if yes defining the time to enter into the queue according to the timer and the priority number of the channel-data, if not, generating the corresponding queue according to the timer and the priority number of the channel-data as the reference so as to define the time for the channel-data to enter into the queue; and
d. retrieving the channel-data in the channel-data switching unit in the queues, displaying the data by the user interface unit and repeating step (a).

11. The method for real-time data scheduling of claim 10, wherein the queue number defines the priority of the data display.

12. The method for real-time data scheduling of claim 11, wherein the channel-data with higher priority of the data display is displayed prior than the channel-data with lower priority of the data display.

13. The method for real-time data scheduling of claim 11, wherein when the channel-data with higher priority of the data display cuts in the queue, the channel-data with higher priority of the data display is displayed prior than the channel-data with lower priority of the data display.

14. The method for real-time data scheduling of claim 10, wherein the channel-data display in the queue follows the FIFO (first in first out) rule.

15. The method for real-time data scheduling of claim 10, wherein when the channel-data in a plurality of queues is empty, pre-determined data with timer defining the display time of a later period is displayed simultaneously.

16. The method for real-time data scheduling of claim 15, wherein the pre-determined data is an advertisement.

17. The method for real-time data scheduling of claim 10, wherein the server provides the user interface.

18. The method for real-time data scheduling of claim 20, wherein the channel-data is dependent upon client request of including a selected plurality of channel units.

19. A system for real-time data scheduling comprising:
a server used for receiving a channel request and providing a corresponding channel-data, wherein the channel-data further comprising a timer and a queue number; and
a client having a user interface unit, a plurality of queues and a plurality of channel units,
wherein, the channel unit sends a channel request, receives corresponding channel-data, defines the time to enter into a plurality of queues according to the timer of the channel-data, and defining the order of the channel-data in the corresponding queue according to the queue number of the channel-data.

20. The system for real-time data scheduling of claim 19, wherein the queue number defines the priority of the data display.

21. The system for real-time data scheduling of claim 20, wherein the channel-data with higher priority of the data display is displayed prior than the channel-data with lower priority of the data display.

22. The system for real-time data scheduling of claim 20, wherein when the channel-data with higher priority of the data display cuts in the queue, the channel-data with higher priority of the data display is displayed prior than the channel-data with lower priority of the data display.

23. The system for real-time data scheduling of claim 19, wherein the channel-data display in the queue follows the FIFO (first in first out) rule.

24. The system for real-time data scheduling of claim 19, wherein when the channel-data in a plurality of queues is empty, pre-determined data with timer defining the display time of a later period is displayed simultaneously.

25. The system for real-time data scheduling of claim 24, wherein the pre-determined data is an advertisement.

26. The system for real-time data scheduling of claim 19, wherein the server provides the user interface.

27. The system for real-time data scheduling of claim 19, wherein the channel-data is dependent upon client request of including a selected plurality of channel units.

28. A system for real-time data scheduling comprising:
a server used for receiving a channel request and providing a corresponding channel-data, wherein the channel-data further comprising a timer and a timer and a priority number; and
a client having a user interface unit and a plurality of channel units;
wherein, the channel unit sends a channel request, receives the corresponding channel-data, determines whether the client generates a corresponding queue according to the priority number of the channel-data, if yes, defines the time to enter into the queue according to the timer and the priority number of the channel-data, if not, generates the corresponding queue according to the timer and the priority number of the channel-data as the reference so as to define the time for the channel-data to enter into the queue.

29. The system for real-time data scheduling of claim 28, wherein the queue number defines the priority of the data display.

30. The system for real-time data scheduling of claim 29, wherein the channel-data with higher priority of the data display is displayed prior than the channel-data with lower priority of the data display.

31. The system for real-time data scheduling of claim 29, wherein when the channel-data with higher priority of the data display cuts in the queue, the channel-data with higher priority of the data display is displayed prior than the channel-data with lower priority of the data display.

32. The system for real-time data scheduling of claim 28, wherein the channel-data display in the queue follows the FIFO (first in first out) rule.

33. The system for real-time data scheduling of claim 28, wherein when the channel-data in a plurality of queues is empty, pre-determined data with timer defining the display time of a later period is displayed simultaneously.

34. The system for real-time data scheduling of claim 33, wherein the pre-determined data is an advertisement.

35. The system for real-time data scheduling of claim 28, wherein the server provides the user interface.

36. The system for real-time data scheduling of claim 28, wherein the channel-data is dependent upon client request of including a selected plurality of channel units.
